(19) United States
(12) Patent Application Publication
(10) Pub. No.: US 2008/0182570 A1
(43) Pub. Date: Jul. 31, 2008

(54) Device and Method For Automated Functionality-Based Selective Establishing of Wireless Data Communication Connections

(76) Inventor: Carmen Kuhl, Dortmund (DE)

Correspondence Address: Erin M. Nichols;Hollingsworth & Funk, 8009 34th Avenue South, Suite 125, Minneapolis, MN, 55425, US

(21) Appl. No.: 11/596,905

(22) PCT Filed: May 21, 2004
(86) PCT No.: PCT/IB04/01645

§ 371 Date: Sep. 26, 2007

(51) Int. Cl. H04Q 7/20; H04M 1/00

(52) U.S. Cl. 455/422.1; 455/550.1

(57) ABSTRACT

An electronic device and a method for automated functionality-based selective establishing of wireless data communication connections are provided. The device comprises at least a wireless data communication interface and an identification device. The wireless data communication interface is adapted for wireless data communication with a counterpart device, which is equipped with a corresponding wireless data communication interface. The identification device is adapted to separately obtaining identification information from a counterpart identification device, which is associated with the counterpart device. The identification information obtained from the counterpart identification device relates to identification information concerning the counterpart device. In particular, the identification information includes at least functionality information relating to the counterpart device. The functionality information is adapted to enable the automated functionality-based selective establishing of a wireless data communication connection via the wireless data communication interface with the counterpart device in accordance with the profile information.

The present invention relates to a device capable for wireless communication and a method for establishing the wireless communication in particular with a counterpart device. More particularly, the establishing of the wireless communication with the counterpart device takes advantage and into account of functionality and capability of the counterpart device, respectively.

The original purpose of local wireless data communication connection for consumer electronic devices has been oriented towards the need for substituting wired connections between consumer electronic devices and its peripheral devices. In particular, the success of such local wireless data communication connection technologies developed in view of this purpose can be observed in the field of portable consumer electronic devices widely spread among consumers of industrial nations. Portable consumer electronic devices relate especially to portable computers, personal digital assistants (PDA), electronic organizers, cellular telephone terminals and the like.

In the field of cellular communications, the usage of local wireless data communication technology might be explained exemplary without limiting thereto. Different peripheral devices for radio terminal devices are well known in the field of cellular communication. The most common peripheral device for cellular terminal is represented by a headset originally connected wire-based to the cellular terminal and today preferably connected thereto with the help of interfaces being based on wireless data communication technology. So-called multipart cellular terminal arrangements being presently under development represent a continuation of this concept. A multipart cellular terminal arrangement is basically constituted by a core device, to which a plurality of specific peripheral devices is connected. Type-specifically, the core device serves for communications with the public land mobile network (PLMN) and routes specifically and selectively the communications with the public land mobile network (PLMN) to one or more peripheral devices acting as (physical and logical) interfaces for the user; i.e. specifically and selectively with respect to the functionality of the one or more peripheral devices.

Design and functionality of the peripheral devices fit in with demands of customers for adaptation of multipart cellular terminals to different fields of use in order to allow substitution for several separate cellular terminal devices each specifically adapted to one specific field of use. For instance, one peripheral device may be optimized for basic phone functionality required for private use, another one may be optimized for contact handling, messaging, browsing etc functionality required primarily for business use, a further one may be optimized for hand-free phone functionality such as used in motor vehicles, another further one may be optimized for video and music reproduction functionality and the like, only to present a selection of possible functionalities of specific peripheral devices.

In principle, wireless data communication connections are conventionally employed between electronic consumer devices to enable flexibility and usability requested by users and especially between terminal devices and peripheral devices functional associateable with the terminal devices.

Conventionally, low power radio frequency connections, for instance in accordance with the Bluetooth wireless communication standard, are selected for wireless connections. The establishment of wireless connections between for example a cellular terminal and a peripheral device follows standardized procedures, which on the one hand provide for flexibility and on the other hand guarantee security issues such that the user has control over the establishment. In view of such arrangements, where one or more peripheral devices take over the user interface functionality, the users have to manage the hand over of the interface functionality between the peripheral devices when connecting a peripheral device to the terminal device.

A problem arises in this context when users of less technical knowledge have to handle such standardized procedures for establishing wireless connections and handing over interface functionality. To meet security issues, user interactions during establishing and handing over procedures are required, which may overtax the knowledge of an average user. Although users are conventionally guided by adequate user interfaces through these procedures, nevertheless the procedures may appear complicate and confusing to users.

Another problem arises in this context when considering the usability of such procedures. The user interactions required during establishing and handing over connections are above all disadvantageous when peripheral devices of a terminal device are exchanged, since user interactions are required each time of exchange. This circumstance may appear to users as being elaborate and awkward.

The overall object of the present invention is to overcome the above-described problems. In particular, a detail object of the present invention is to provide a method of allowing fast constitution of wireless communication connections which is sensitive to the functionality provided by the devices coupled by the wireless communication connection.

Advantages of the present invention will become apparent to the reader of the present invention when reading the detailed description referring to embodiments of the present invention, based on which the inventive concept is easily understandable.

According to a first aspect of the present invention, an electronic device for automated functionality-based selective establishing of wireless data communication connections is provided. The device comprises at least a wireless data communication interface and an identification device. The wireless data communication interface is adapted for wireless data communication with a counterpart device, which is equipped with a corresponding wireless data communication interface. The identification device is adapted to separately obtaining identification information from a counterpart identification device, which is associated with the counterpart device. The identification information obtained from the counterpart identification device relates to identification information concerning the counterpart device. In particular, the identification information includes at least functionality information relating to the counterpart device. The functionality information is adapted to enable the automated functionality-based selective establishing of a wireless data communication connection via the wireless data communication interface with the counterpart device in accordance with the profile information.

Herein the functionality information shall be understood as an information, which relates to the counterpart device, and in more detail, to the functionality of the counterpart device, the type of the counterpart device, the capabilities of the counterpart device, the services supported and/or provided for usage by the counterpart device, the functions implemented in the counterpart device, and the like. This means, the functionality information should be appreciated as a technical description of the device, its functionality, its functions, which are of interest for the inquiring electronic device intending to utilize the counterpart device according to its functionality provided to at least the external inquiring electronic device or any inquiring electronic device of the defined type.

According to an embodiment of the present invention, the identification information includes additionally configuration information. The configuration information relates to establishing of the wireless data communication connection. In particular, the configuration information is formed to allow automated establishing of the wireless data communication connection to the counterpart device by the means of the wireless data communication interface.

According to an embodiment of the present invention, the configuration information comprises at least one out of a group of configuration information including configuration information of the wireless data communication interface and the wireless data communication connection, identity information, authentication information and address information of the counterpart device.

According to an embodiment of the present invention, the functionality information comprises at least one out of a group of functionality information including information about capabilities of the counterpart device; information about functions of the counterpart device; and information about features of the counterpart device.

According to an embodiment of the present invention, the electronic device comprises a configuring component, which is adapted to check whether there presently exists one or more wireless data communication connections. In case there do not exist presently any wireless data communication connections, the configuring component is adapted to establish the wireless data communication connection.

According to an embodiment of the present invention, the electronic device comprises a configuring component, which is further adapted to check whether functionality associated with a presently existing wireless data communication connection corresponds to the profile information. In case the functionality differs from the profile information, the configuring component is adapted to establish the wireless data communication connection.

According to an embodiment of the present invention, the wireless data communication interface is a low power radio frequency transceiver.

According to an embodiment of the present invention, the identification device is a radio frequency identification device and in particular a radio frequency identification reader device.

According to an embodiment of the present invention, the counterpart identification device is a radio frequency identification device and in particular a radio frequency identification transponder device.

According to a second aspect of the present invention, a system for automated functionality-based selective establishing of wireless data communication connections is provided. The system comprises a counterpart device with a wireless data communication interface, a counterpart identification device associated with the counterpart device (500, 501); and an electronic device. The electronic device comprises further a wireless data communication interface for communicating wirelessly data with the counterpart device and an identification device for separately obtaining identification information from the counterpart identification device. The identification information includes at least functionality information relating to a functionality of the counterpart device. The functionality information is adapted to allow for automated functionality-based selective establishing of a wireless data communication connection via the wireless data communication interfaces of the electronic device and the counterpart device with the counterpart device in accordance with the profile information.

According to a third aspect of the present invention, a method for automated functionality-based selective establishing of wireless data communication connections is provided. Identification information is obtained by an identification device from a counterpart identification device, which is associated with a counterpart device. The identification information includes at least profile information, which relates to a functionality of the counterpart device. Subsequently a wireless data communication connection is automatically functionality-based selectively established via a wireless data communication interface to the counterpart device in accordance with the profile information.

According to an embodiment of the present invention, the identification information includes additionally configuration information. The configuration information relates to establishing of the wireless data communication connection. In particular, the configuration information is formed to allow automated establishing of the wireless data communication connection to the counterpart device by the means of the wireless data communication interface.

According to an embodiment of the present invention, it is checked whether there presently exists one or more wireless data communication connections. In case there do not exist presently any wireless data communication connections, the wireless data communication connection is established.

According to an embodiment of the present invention, it is checked whether a functionality associated with a presently existing wireless data communication connection corresponds to the profile information. In case the functionality differs from the profile information, the wireless data communication connection is established.

According to an embodiment of the present invention, the user is requested and in accordance with a user acknowledgement a wireless data communication connection is added by establishing the wireless data communication connection or a presently existing wireless data communication connection is replaced by de-establishing the presently existing wireless data communication connection and establishing a new wireless data communication connection.

According to an embodiment of the present invention, the functionality information comprises at least one out of a group of functionality information including information about capabilities of the counterpart device; information about functions of the counterpart device; and information about features of the counterpart device.

According to an embodiment of the present invention, the obtaining of identification information from the counterpart identification device is triggered by approaching the identification device into a proximity of the counterpart identification device.

According to an embodiment of the present invention, the wireless data communication interface is a low power radio frequency transceiver.

According to an embodiment of the present invention, the identification device is a radio frequency identification device and in particular a radio frequency identification reader device.

According to a fourth aspect of the present invention, computer program product for executing a method for automated context information based selective data provision for identification means is provided. The computer program product comprises program code sections for carrying out the steps of the method according to an aforementioned embodiment of the invention, when the program is run on a computer, a terminal, a network device, a mobile terminal, a mobile communication enabled terminal or an application specific integrated circuit. Alternatively, an application specific integrated circuit (ASIC) may implement one or more instructions that are adapted to realize the aforementioned steps of the method of an aforementioned embodiment of the invention, i.e. equivalent with the aforementioned computer program product.

According to a fifth aspect of the present invention, a computer program product is provided, which comprises program code sections stored on a machine-readable medium for carrying out the steps of the method according to an aforementioned embodiment of the invention, when the computer program product is run on a computer, a terminal, a network device, a mobile terminal, or a mobile communication enabled terminal.

According to a sixth aspect of the present invention, a software tool is provided. The software tool comprises program portions for carrying out the operations of the aforementioned methods when the software tool is implemented in a computer program and/or executed.

According to an seventh aspect of the present invention, a computer data signal embodied in a carrier wave and representing instructions is provided which when executed by a processor cause the steps of the method according to an aforementioned embodiment of the invention to be carried out.

The accompanying drawings are included to provide a further understanding of the invention, and are incorporated in and constitute a part of this specification. The drawings illustrate embodiments of the present invention and together with the description serve to explain the principles of the invention. In the drawings,

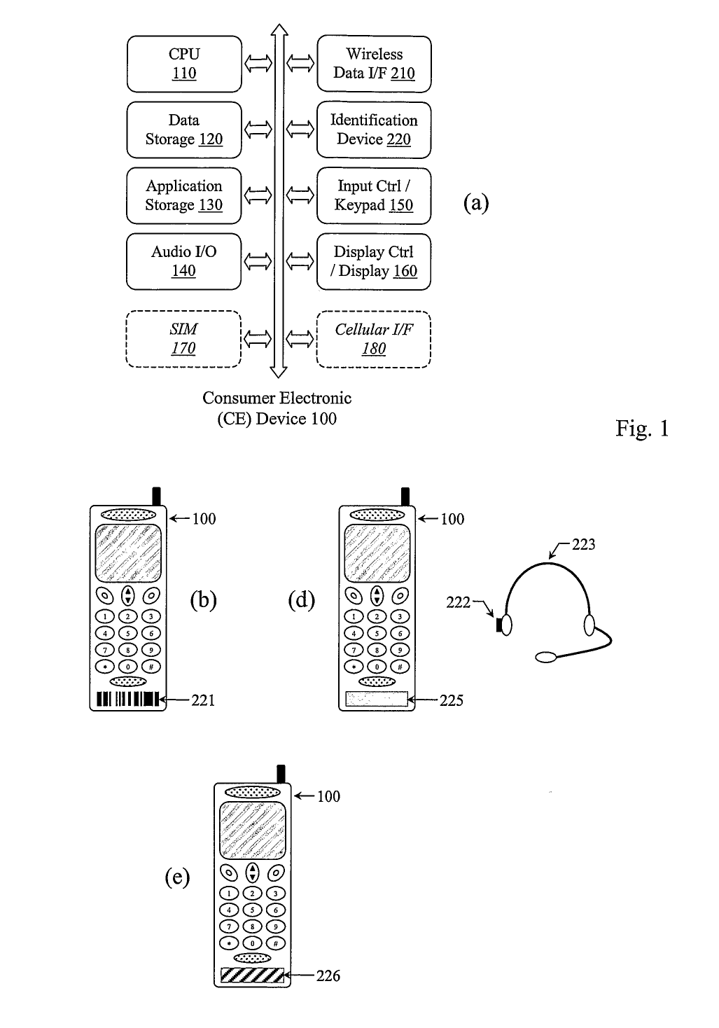

FIG. 1(a) illustrates a consumer electronic (CE) device according to an embodiment of the present invention;

FIG. 1(b) to (e) illustrates shows various example implementations of identification devices applicable with embodiments of the present invention;

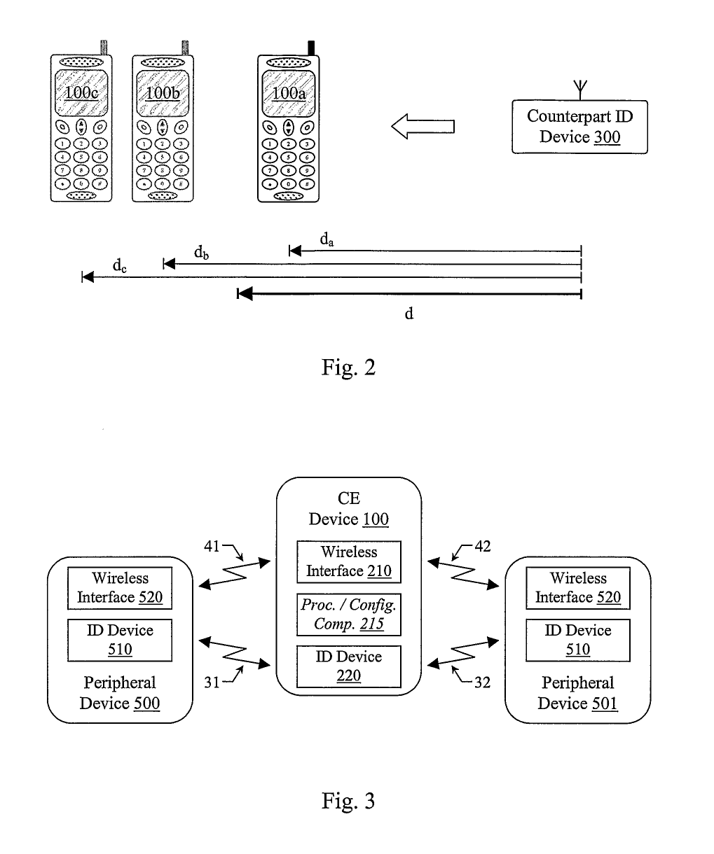

FIG. 2 schematically illustrates an arrangement of portable CE devices, which implement identification devices for exchanging information with a counterpart identification device according to an embodiment of the invention;

FIG. 3 illustrates an arrangement of the consumer electronic device and several counterpart devices according to an embodiment of the present invention;

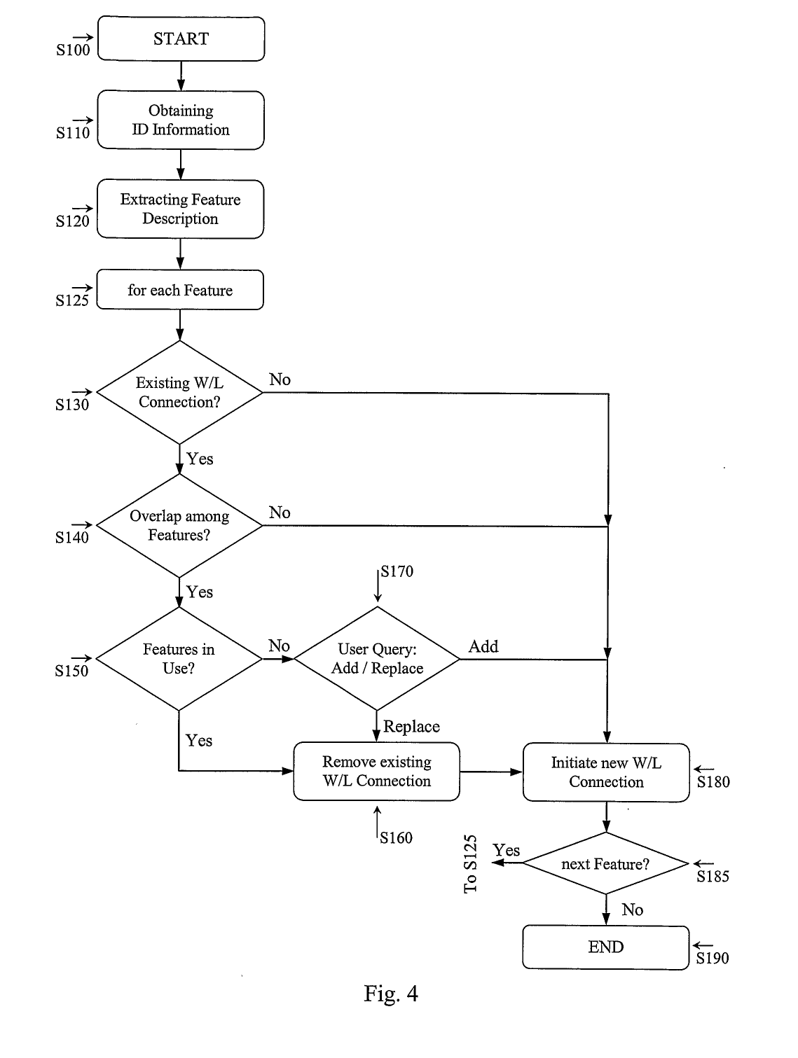

FIG. 4 illustrates an operational sequence for automated functionality-based establishing of a wireless data communication connection according to an embodiment of the present invention.

Reference will be made in detail to the embodiments of the invention examples, which are illustrated in the accompanying drawings. Wherever possible same reference numbers are used throughout drawings and description to refer to similar or like parts.

The following description relates to various embodiments based on which the skilled reader will understand the basic concept of the present invention. Nevertheless, the skilled reader will appreciate that the inventive concept is likewise applicable to further embodiments, which are covered by the scope of the accompanying claims.

The block diagram of FIG. 1a illustrates a principle structural component design of a cellular terminal, which should exemplary represent any kind of portable consumer electronic (CE) device 100 employable with the present invention. It shall be understood that the present invention is not limited to any specific kind of portable CE device such as that illustrated one. The illustrated portable CE device 100, which is carried out as a processor-based device, comprises typically a central processing unit (CPU) 110, a data storage 120, an application storage 130 and input/output means including audio input/output (I/O) means 140 typically a microphone and a loudspeaker, a keypad with a (key) input controller (Ctrl) 150 and a display with a display controller (Ctrl) 160.

The display and display controller (Ctrl) 160 are controlled by the central processing unit (CPU) 110 and provides information for the user. The keypad and keypad controller (Ctrl) 150 are provided to allow the user to input information. The information input via the keypad is supplied to the central processing unit (CPU) 110, which may be controlled in accordance with the input information. The audio input/output (I/O) means 140 includes at least a speaker for reproducing an audio signal and a microphone for recording an audio signal. The central processing unit (CPU) 110 may control the conversion of audio data to audio output signals and the conversion of audio input signals into audio data, where for instance the audio data have a suitable format for transmission and storing.

Additionally, the portable CE device 100 according to a specific embodiment of the present invention includes optionally a cellular interface (I/F) 180 coupled to a cellular antenna and operable with a corresponding subscriber identification module (SIM) 170. The cellular interface (I/F) 180 is arranged as a cellular transceiver to receive signals from the cellular antenna, decodes the signals, demodulates them and also reduces them to the base band frequency. The cellular interface 180 provides for an over-the-air interface, which serves in conjunction with the subscriber identification module (SIM) 170 for cellular communications with a corresponding radio access network (RAN) of a public land mobile network (PLMN). The output of the cellular interface (I/F) 180 thus consists of a stream of data that may require further processing by the central processing unit (CPU) 110. The cellular interface (I/F) 180 arranged as a cellular transceiver also receives data from the central processing unit (CPU) 110, which are to be transmitted via the over-the-air interface to the radio access network (RAN). Therefore, the cellular interface (I/F) 180 encodes, modulates and up converts the signal to the radio frequency, which is to be used. The cellular antenna then transmits the resulting radio frequency signal to the corresponding radio access network (RAN) of the public land mobile network (PLMN).

A local (short-range) wireless data interface (I/F) 210 or local (short-range) wireless transceiver is further implemented in the portable CE device 100 to provide for local wireless data communication with a corresponding counterpart network, base station and transceiver, respectively. A broad number of different technologies and standards are applicable for implementing such a local (short-range) wireless data interface (I/F) 210.

In general, the local data interface (I/F) 210 can be realized by a low-power radio frequency (LPRF) transceiver such as a Bluetooth transceiver, a WLAN (wireless local area network) transceiver, an ultra-wide band (UWB) transceiver or any other transceiver e.g. operable with an IEEE 802.xx standard. Moreover, the local data interface (I/F) 210 can be also implemented as an infrared-based interface such as an IrDA (infrared direct access) interface or any other proprietary radio frequency and optical interface, respectively.

An identification device 220 and especially an identification reader device is operable with the aforementioned portable CE device 100 embodied herein as a cellular terminal for the way of illustration. Different identification technologies can be applied in accordance with embodiment of the present invention, which identification technologies allow for serving identification information for enabling the automated functionality-based establishment of a wireless data communication connection. An example selection of applicable identification technologies for communicating identification information will be presented below with reference to FIG. 1(b) to 1(e). The contents of the identification information and the performing of the inventive automated functionality-based establishment of a wireless data communication connection will be subject of the description referring to FIG. 3 and 4.

The identification device 220 may be implemented in, attached to or coupled to the portable CE device 100 according to embodiments of the present invention. For instance, the identification device 220 may be provided externally to the portable CE device 100 integrated into a detachable functional cover. This means that the cover, when attached to the portable CE device 100, provides for identification functionality.

More generally, the identification device 220 is as well connectable with the portable CE device 100 via a dedicated data interface (I/F) (not shown). The data interface (I/F) serves for interfacing data and instruction communications between the identification device 220 and the portable CE device 100. The data interface (I/F) may be established by any appropriate hardware and/or software interfaces, which are available in the state of the art or in future.

With reference to FIG. 1(b), visual identification technology shall be presented. Visual identification technology shall be understood as comprising one-dimensional and two-dimensional visual codes such as bar codes, which allow to code information visually, i.e. designated herein as identification information, and optical scanning means, which are adapted to detect one-dimensional or two-dimensional visual codes. The optical scanning means typically implement visual or infrared laser diodes for illuminating visual codes and correspondingly adapted optical photo diodes for detecting the visual code patterns.

In accordance with FIG. 1(b), the identification device 220 of the portable CE device 100 is implementable as an optical scanning means 221 for detecting one-dimensional or two-dimensional visual codes. The optical scanning means 221 is merely illustrated schematically in FIG. 1 (b). The one-dimensional or two-dimensional visual codes to be detected may be visualized by the means of a display adapted to display various visual codes or any conventional display having adequate display properties. As aforementioned, one-dimensional or two-dimensional visual codes allow encoding any informational contents typically on the basis of a standard encoding methodology for alphanumeric information.

With reference to FIG. 1(d), radio frequency identification (RFID) technology shall be presented. Radio frequency identification (RFID) technology should be understood as comprising radio frequency identification (RFID) transponder devices and radio frequency identification (RFID) reader devices. Such RFID transponders are well known and generally comprise an integrated circuit having an antenna element. The integrated circuit includes a storage for storing information, i.e. in particular, its identification information. The integrated circuit comprises a transponder logic. Corresponding, RFID readers emit a radio frequency interrogation signal. Preferably, the frequency of the interrogation signal is selected to prevent interference with the other wireless data interfaces (I/F) such as the local wireless data interface (I/F) 210 and the optional cellular interface (I/F) 180. The interrogation signal constitutes a magnetic flux field that is magnetically coupled into the antenna to energize the integrated circuit and the transponder logic, respectively. Accordingly, battery or power supply is optional for RFID transponders. When a RFID transponder has been energized, the integrated circuitry thereof assembles a radio frequency response signal which carries the stored information, in particular the stored identification information of the RFID transponder. This radio frequency response signal is fed to the antenna, which causes the antenna to emit the radio frequency response signal carrying the stored information, which is then receivable by the interrogating RFID reader. The RFID reader is thus able to obtain the information stored in the RFID transponder. It should be appreciated that any alternative embodiment of the radio frequency identification (RFID) transponder and radio frequency identification reader might be applicable in alternative embodiments of the present invention.

The radio frequency identification (RFID) transponder devices and radio frequency identification (RFID) reader devices can be implemented in any electronic device or can be incorporated on an exterior surface of any electronic device. However, the radio frequency identification (RFID) transponder devices and radio frequency identification (RFID) reader devices can be provided inside or outside casings.

In accordance with FIG. 1(d), the portable CE device 100 is equipped with a radio frequency identification (RFID) reader device 225, which is capable to retrieve wirelessly the identification information from the radio frequency identification (RFID) transponder device 222, which is mounted on a headset 223.

With reference to FIG. 1(e), magnetic identification technology shall be presented. Magnetic identification technology shall be understood as comprising a magnetic medium such as a magnetic strip, which allow to store magnetically information, herein designated as identification information, and magnetic reader devices, which are adapted to reader the information stored on the magnetic medium. In accordance with FIG. 1 (e), the identification device 220 of the portable CE device 100 is implementable as a magnetic reader device 226 for detecting magnetically stored information provided on magnetic media. The magnetic reader device 226 is merely illustrated schematically in FIG. 1(e).

Conclusively, the skilled reader should appreciate on the basis of the description above that the portable CE device 100 may represent illustratively anyone of a plurality of devices comprising in a non-limiting way a cellular terminal, a personal digital assistant, a pocket personal computer, an electronic organizer, a portable personal computer, a communicator terminal or any other consumer electronics (CE) with processing capability and appropriate communication means, where the communication means comprise at least a wireless data interface 210 and an identification device 220. In accordance with the description above, those skilled in the art should likewise note that the identification device 220 is generally adapted for obtaining identification information from a counterpart identification device. In general, the portable CE device 100 embodies a processor-based device, which allows implementation of the inventive concept.

Referring firstly to FIG. 2, a portable CE device 100a shall be equipped with an identification device such as identification device 220, which at least serves for obtaining identification information provided by any counterpart identification device preferably integrated into, coupled to or connected to any counterpart device. This means, the portable CE device 100a comprises for example one kind of the aforementioned identification devices.

Information communications between identification devices may be arranged to be strictly limited to a predefined communication distance. The strict limitation of the communication distance meets security aspects of the information communication between the participating identification devices. This means, an information communication is possible as soon as the distance between the participating identification devices falls below a predefined maximal distance, which is typically a function of power levels and range of the employed physical signal, respectively, carrying the identification information. The communication distance may be defined exemplary by a maximal distance d. Portable terminals such as portable terminal 100a, which is spaced at a distance da smaller than distance d, are able to communicate with the counterpart identification device. Portable CE devices such as portable CE devices 100b and 100c, which are spaced at distances d_{b} and d_{c} larger than distance d, are not able to communicate with the counterpart identification device. The limitation of the communication distance relates to several aspects, which may be summarized as security issues. The limited communication distance is applicable to prevent from accidentally and/or maliciously obtaining information stored in the identification device of the portable terminal. Assuming the maximal communication distance is selected to be in the order of centimeters, identification devices exchanging information have to be such close to each other that the possibility of an accidental or a malicious information exchange can essentially be ruled out. The limited communication distance is also applicable to prevent tapping of information exchanged between communicating identification devices. Third party means, which allows tapping, ought to be as close to the communicating identification devices that the tapping operation gets evident at once. The limitation of the communication distance may be limited to such a short distance that the communicating identification devices have to be placed into physical contact or nearly into physical contact. In a specific embodiment, the communicating identification devices have to (at least almost) touch each other during the communication operation. An accidental or a malicious information acquisition and a tapping of communicated information are practically impossible, respectively.

With reference back to FIG. 1(d), a specific embodiment of the present invention should be described. The identification information provided by the counterpart identification device 300 embodied as radio frequency identification (RFID) transponder device is obtainable by the identification device 220 comprised by the portable CE device 100a, where the identification device 220 of the portable CE device 100 is embodied as a radio frequency identification (RFID) reader device. The RFID reader device (220) activates (and if necessary energizes simultaneously) the RFID transponder device (300) with the help of an interrogation signal, upon which the RFID transponder device (300) transmits back the identification information stored therein to the RFID reader device (220).

The communication distance for communication between communicating radio frequency identification (RFID) devices is predetermined by the physical signal strength of the interrogating signal and the response signal carrying the identification information. Whereas the physical signal strength of the interrogating signal depends on the output power of the RFID reader device, the physical signal strength of the interrogating signal depends on the efficiency of the antenna receiving the interrogating signal as well as transponder logic and the design of the antenna emitting the response signal.

It shall be further noted, that the communication of identification information is likewise operable between RFID reader devices supporting for instance the near field communication standard. Alternatively, a RFID reader device having writing capability may be applicable for writing identification information into a radio frequency identification (RFID) transponder device.

The inventive concept will be described in the following with reference to a specific embodiment comprising a multipart cellular terminal, which employs radio frequency identification (RFID) technology for communicating identification information. It shall be noted that the invention is not limited to this specific embodiment. Nevertheless, those skilled in the art will appreciate the general functionality and capability provided by the described inventive concept.

FIG. 3 illustrates the portable CE device 100 and peripheral devices 500 and 501, which may represent an arbitrary number of peripheral devices. For the way of illustration, a selection of functional components of the portable CE device 100 and the peripheral devices 500 and 501 is additional illustrated. The illustrated functional components/units represent a selection of specific functional components being relevant for operating the portable CE device in accordance with the inventive concept of the present invention. For proper operation and functioning, the portable CE device 100 and the peripheral devices 500 and 501 may comprise further functional components. The complete implementation of the portable CE device 100 and the peripheral devices 500 and 501 is out of the scope of the present invention, respectively.

Referring to the portable CE device 100, the functional components comprise a wireless data interface (I/F) 210, identification (ID) device 220 and a component 215 required for processing the identification information obtained by the identification device 220 and controlling the establishing of wireless data communication connections in accordance with the processing results. In correspondence to the implementation of the portable CE device 100, the peripheral devices 500 and 501 serving as counterpart devices each comprise functional components including an identification (ID) device 5 10 and a wireless data interface (I/F) 520.

The wireless data interfaces (I/F) 210 and 520 of the portable CE device 100 and the peripheral devices 500, 501 should represent illustratively any wireless data communications technology enabling wireless data communications therebetween. Low power radio frequency (LPRF) transceivers represent one typical class of wireless data interfaces (I/F) in the field of wireless communications applicable for wireless data and voice signal communications. In particular, Bluetooth transceivers, wireless local area network (WLAN) transceivers, ultra-wide band (UWB) transceivers, IEEE 802.xx standard transceivers and digital enhanced cordless telecommunication (DECT) transceivers can be classed as belonging to the field of low power radio frequency (LPRF) technology. Also infrared-based (IrDA: infrared data association) transceivers are applicable for wireless data and voice signal communications. The inventive concept supports fast establishing of data communication connections via wireless communication interfaces in general such that the wireless interfaces 210 and 520 may also address cellular communication technology in the form of cellular interfaces.

In the field of portable CE devices, low power radio frequency (LPRF) technology is a typical wireless data communication technology of choice, such that the wireless data interfaces 210 and 520 may be implemented as low power radio frequency (LPRF) transceivers and more particularly as Bluetooth transceivers.

The identification devices 220 and 510 relate also to a wireless exchange of identification information but with the difference that the identification devices 220 and 510 shall be limited to a capability to exchange predefined information or a set of predefined information therebetween via information exchange paths 31 and 32, respectively. The designation information exchange shall further emphasis that in contrast to wireless data communication technology as introduced above in conjunction with the wireless data interfaces (I/F) 210 and 520, the identification devices 220 and 510 need principally not to be capable for bi-directional data communications, which is known in combination with wireless data communication technology allowing for constituting a wireless data communication network.

Moreover, the identification devices 220 and 510 shall operate over very short spacious distances; i.e. over distances which are significantly shorter than the operation distances of wireless data interfaces (I/F) 210 and 520, which may for instance vary from the order of meters (Bluetooth) to the order of hundreds for meters (WLAN) depending naturally on the employed technology and/or environmental effects. In particular, the identification devices 220 and 510 may operate at a spacious distance in the order of centimeters.

The purpose of the implementation of the identification devices 220 and 510 is to selectively limit the information exchange to devices being located in a predefined proximity, whereas the communication connection constituted afterwards on the basis of information exchanged is operable within a spacious distance defined by the employed technology. This concept may serve as a kind of authentication methodology when assuming that the required spacious approach can not take place accidentally, unnoticed and unintentionally. Conclusively, due to the fact that a constitution of a communication connection is operated by information exchange limited by spacious operation distance, a misuse by an unauthorized third party is prevented.

A suitable implementation of identification devices 220 and 510 may be realized by employing RFID technology comprising RFID transponder devices and RFID reader devices. Depending on the design, such RFID transponder devices are applicable to provide information that is obtainable by a corresponding RFID reader device via a radio frequency connection.

The inventive concept of the present invention relates in principle to a fast, an automated, a selective and a functionality-based establishing of wireless data communication between the portable CE device 100 and a counterpart device, herein its one or more peripheral devices 500 and 501, which establishing should meet usability requirements necessary in view of consumers. It should be remarked that the present invention is not limited to any specific arrangement such as the illustrated arrangement of the portable CE device and its peripheral devices. Nevertheless, the following operational sequence according to an embodiment of the present invention shall be described with reference to that aforementioned arrangement.

The operations required to enable to functionality-based selective establishing of wireless data communication according to an embodiment of the present invention is operated by the means of a processing and configuring component 215, which forms a hardware and/or software component carrying out the operations. An embodiment of the operational sequence carried out by the processing and configuring component 215 is described in detail with reference to FIG. 4 which description follows.

With reference to FIG. 4, the operational sequence according to an embodiment of the present invention is illustrated. The operational sequence is to be carried out by a portable CE device 100, which operates the initiative to establish a wireless data communication with a counterpart device. In view of the aforementioned arrangement, the counterpart device is one of the peripheral devices 500 and 501.

References to a specific use case shall support the description of the operational sequence, which use case comprises a portable cellular terminal such as the portable CE device 100 and accessory device 500 and 501 including a headset and a car handsfree speaking system, generally also known as a car kit. Both the headset and a car kit can be coupled wirelessly to the portable CE device 100. The simultaneous usage of the audio interfaces being implemented in the headset as well as the car kit is not advisable. Nevertheless, the car kit may provide additional functionality besides the audio interface functionality, which is operable simultaneously with the headset serving presently as audio interface. Moreover, a presently coupled headset may be replaced by the audio interface of the car kit.

Now, references will be given to the operations illustrated in FIG. 4, which illustrates operations of the portable CE device in a general way.

In an operation S100, the operational sequence for automated functionality-based selective establishing of a wireless data communication connection starts.

In an operation S110, identification information is obtained from a counterpart identification device associated with a counterpart device, to which counterpart device a wireless data communication connection is intended to be established, which wireless data communication connection is to be operated by the means of the wireless data interfaces (I/F) 210. The identification information is obtained by the means of the identification devices 220 comprised by the portable CE device 100 operating the current operational sequence.

The obtaining of the identification information from the counterpart identification device of the counterpart device may trigger the portable CE device 100 to carry out the operational sequence illustrated herein. This means, the identification device 220 of the portable CE device 100 may independently scan for identification devices of potential counterpart devices or may scan for identification devices of potential counterpart devices in accordance with a user instruction. Once, the portable CE device 100 obtains identification information suitable for the present discussed operational sequence, the operational sequence processing of the identification information in accordance with the operational sequence illustrated herein is initiated.

The identification information includes typically suitable configuration information to allow the connection to be established automatically, i.e. omitting any user interaction. In particular, the identification information includes an identifier or address information of the wireless data interface of the counterpart device to be addressed for establishing the intended wireless data communication. More particularly, the identification information includes an identification and/or authentication information, which may be required for identifying and/or authenticating purposes during the establishing of the wireless data communication.

Additionally, the identification information contains profile information about the functionality of the counterpart device, which functionality relates to the capabilities, functions and/or features of the counterpart device, which are applicable via the wireless data communication connection intended to be established. The profile information about the functionality of the counterpart device may be designated as device profile information, wherein the profile information about the functionality may relate to functionality specific for the wireless data interface of the counterpart device, the functionality of the counterpart device itself, services provided by the counterpart device etc. It shall be noted that the profile information about the functionality of the counterpart device may relate to one or more separate functionalities of the counterpart device. This means, with reference to the aforementioned use case, the car kit comprises for instance an audio input/output interface, a display and input keys, wherein each of these denoted components are understood as separate functionalities.

When referring to a specific embodiment including Bluetooth transceivers as wireless data interfaces (I/F), the profile information about the functionality includes Bluetooth profile information and Bluetooth class information. The Bluetooth profiles and classes are dedicated to reflect the functionality, capabilities and features supported by devices having a Bluetooth interface. Similar profile and class information is likewise definable in conjunction with the several aforementioned wireless data interfaces also applicable with embodiments of the present invention.

With reference to the currently available Bluetooth specification, an exemplary selection of Bluetooth profiles should be presented for the way of illustration. The Bluetooth profiles comprises Generic Access Profile (GAP), Service Discovery Application Profile (SDAP), Cordless Telephony Profile (CTP), Intercom Profile (IP), Serial Port Profile (SPP), Headset Profile (HS), Dial-up Networking Profile (DNP), Fax Profile (FP), LAN (Local Area Network) Access Profile (LAP), Generic Object Exchange Profile (GOEP), Object Push Profile (OPP), File Transfer Profile (FTP), and Synchronization Profile (SP). The additional Bluetooth profiles currently under development comprise Extended Service Discovery Profile (for Universal Plug and Play) (ESDP), Advanced Audio Distribution Profile (A2DP), Audio Video Remote Control Profile (AVRCP), Basic Imaging Profile (BIP), Basic Printing Profile (BPP), Common ISDN Access Profile (CIP), Generic Audio Video Distribution Profile (GAVDP), Hands-Free Profile (HFR), Hardcopy Cable Replacement Profile (HCRP), Human Interface Device Profile (HID), and SIM Access Profile (SAP).

The plural of the aforementioned Bluetooth profiles are self-explanatory and define a corresponding use case as well as are associated with specific device functionality as described above. For instance, the Cordless Telephony Profile (CTP) defines the way, in which a Bluetooth-based communication connection can be employed to realize a Bluetooth-based wireless telephone terminal. The Cordless Telephony Profile (CTP) likewise defines the way, in which a Bluetooth-adapted cellular phone should switch to Bluetooth wireless telephone functionality when it comes within the coverage of a Bluetooth-adapted base station.

The Headset Profile (HS) defines the way, in which a Bluetooth-adapted headset should communicate with its associated terminal device, which takes advantage of the audio input/output interface of the Bluetooth-adapted headset.

The Human Interface Device Profile (HID) specifies the use of a Human Interface Device, such as a mouse, keyboard, joystick, etc. communicating human input in or out via a Bluetooth data communication connection to a host device, which is typically a consumer electronic device.

The Hands-Free Profile (HFP) allows hands-free use of an audio gateway such as a cellular terminal by a Hands-Free (HF) installation unit such as a car kit. The Hands-Free (HF) installation unit acts at least as the remote audio input/output mechanism for the cellular terminal. One use case covered in a typical use case is operating a cellular terminal via a car kit, which is installed in a motor vehicle, which car kit allows control over the cellular terminal somewhere in the car.

The SIM Access Profile (SIM) can be applied to allow remote access and control of a SIM module (typically used to configure a cellular terminal) via a Bluetooth data communication connection. The SIM access server has direct access to the SIM module, and acts as the SIM card reader, whereas the SIM access client can access and control the SIM module via the Bluetooth data communication connection.

The Basic Imaging Profile (BIP) is designed to optimize transfer of image information or control from an imaging initiator, such as the consumer electronic device, to select an image feature on an imaging responder, such as a consumer electronic device being equipped with a digital imaging detector such as a digital camera.

The Basic Printing Profile (BPP) is designed to enable wireless printing from a client device such as the consumer electronic device that contains the information, which is pushed to a server device to be printed thereby, which server device is for instance a printer.

Moreover, the Bluetooth specification defines a class of device information, which allows to define a type of the counterpart device, on the basis of which the capabilities of the counterpart device can be indicated and identified, respectively. The class of device information is also denoted as device class for simplicity. The class of device information is further partitioned into a major class of device information and a minor class of device information. The major class of device information comprises preferably one out of a group including computer, phone, LAN/network access point, audio/video, peripheral, imaging miscellaneous. The minor class of device information is based on the major class of device information to specify more particularly the capabilities of the counterpart device.

Class of service information is typically defined in conjunction with class of device information, wherein the class of service information relates analogously to the aforementioned profile information. The class of service information is also denoted for simplicity as service class. The class of service information comprises at least one out of a group of major class of service information including positioning, networking, capturing, object transfer, audio, information, limited discoverable, rendering, telephony. This means, the counterpart device may have assigned multiple major service classes definable with the help of the aforementioned major class of service information.

The service class(es), major device class and minor device class(es) are typical device functionality information, which is handled for instance during a discovery procedure of the counterpart device implementing the Bluetooth transceiver for wireless connecting.

In an operation S120, the profile information is extracted from the obtained identification information. On the basis of the extracted profile information of the counterpart device, from which the profile information has been obtained, currently existing wireless (W/L) data communication connections, if existing presently, are analyzed.

In more detail, the profile information of the counterpart device relates to separate one or more functionalities. Correspondingly, each functionality of the counterpart device defined in the profile information should be considered separately.

In an operation S125, each device functionality is processed separately. This means, any of the following operations S130 to S180 will be performed in accordance with each device functionality of the plurality of device functionalities defined in the profile information.

In an operation S130, it is checked whether there are one or more presently existing wireless (W/L) data communication connections. In case there does not exist presently any wireless (W/L) data communication connection, the operational sequence branches to an operation S180. Otherwise, the operational sequence continues with an operation S140.

In an operation S140, it is checked whether the one or more existing wireless (W/L) communication connections are employed for the usage of device functionality, which overlaps with the functionality defined by the profile information extracted from the obtained identification information. The one or more existing wireless (W/L) data communication connections are preferably established to one or more other counterpart devices, which serve for the device functionality. In case one of the functionalities associated with one or more existing wireless (W/L) data communication connections and the functionality defined by the profile information do not overlap, the operational sequence branches to the operation S180. Otherwise, the operational sequence continues with an operation S150.

In an operation S150, it is checked whether the functionality provided by the counterpart device for usage is currently employed by the means of one of the presently existing wireless data communication connections preferably by the means of one or more counterpart devices, to which the one or more presently existing wireless data communication connections are established. In case that the device functionality in question is presently employed, the operational sequence continues with operation S160, in which the presently existing wireless data communication connection relating to the device functionality is de-established and removed, respectively. Subsequently, the operational sequence continues with the operation S180 for establishing a new wireless data communication connection. For details see below.

In case that the functionality is presently not employed, the operational sequence continues with operation S170, in which the user is requested to decide whether the device functionality presently not used shall be added or replaced. Herein adding should be understood as establishing a new wireless data communication connection to the counterpart device, via which wireless data communication connection the device functionality is applicable. Replacing should be understood as de-establishing the presently existing wireless data communication connection and establishing a new wireless data communication connection to the counterpart device, via which wireless data communication connection the device functionality is applicable.

In case the user acknowledges removing, the operational sequence continues with the operation S160, in which the presently existing wireless data communication connection relating to the functionality is de-established and removed, respectively.

In case the user accepts adding, the existing wireless data communication connection is maintained and the operational sequence continues with the operation S180 for establishing a new wireless data communication connection. For details see below.

With reference to operation S170, it should be noted that the user may also instruct to skip any adding or replacing operations, which causes the operational sequence to skip to an operation S185, in which the operational sequence branches either to continue the processing with a next device functionality or to end the operational sequence.

It shall be noted that the operation S170 might be omitted in case a profile is considered, which usually allows more then one communication connection to be established simultaneously under this profile (e.g. personal area networking (PAN) profile) as it can be assumed that a device can have more then one personal area networking connection at the same time. The “overlapping” communication connection can be added without user query to the communication connection currently present.

In the operation S180, the establishing of the new wireless data communication connection is initiated. The establishing is operable with the configuration information included in the previously obtained identification information. The configuration information is preferably adapted to allow the connection to be established automatically, i.e. in particular omitting any user interaction. Typically, the configuration information relates to interface specific configuration information including for instance address information, identifier information, identity information, authentication information, protocol information, encryption information etc.

In an operation S185, it is checked whether a further device functionality defined in profile information is available to be processed or not. In case, there is a further device functionality available the operational sequence branches back to the operation S125. Otherwise, the operational sequence continues with an operation S190.

In the operation S190, the operational sequence for automated functionality-based selective establishing of the wireless data communication connection ends.

The skilled reader should appreciate that the counterpart identification device associated with the counterpart device may be comprised by the counterpart device, i.e. attached to the counterpart device, integrated into the counterpart device, mounted on the counterpart device etc., but the counterpart identification device associated with the counterpart device may likewise be spaciously separated from the counterpart device.

Those skilled in the art should further understand that the wireless data communication connections discussed above form logical or physical wireless data communication connections, wherein physical wireless data communication connections may carry several logical wireless data communication connections. A logical wireless data communication connection relates to an individual or specific device functionality, capability, function and feature, respectively. Likewise, logical wireless data communication connections may be designated as logical wireless data communication links.

With reference back to the use case aforementioned, assume that the headset is coupled wirelessly to the portable CE device via a presently existing wireless data communication connection, which headset is presently employed as audio input/output interface of the portable CE device. At once, the user inserts his portable CE device into a support for the portable CE device installed in his car, an identification information stored in an identification device integrated into the support is obtained, which identification device is associated with the car kit. The obtained identification information including profile information about the functionalities of the car kit indicate to the portable CE device that the lien-fit car kit also provides an audio input/output interface. Consequently, the wireless data communication connection to the headset wirelessly coupling the headset to the portable CE device for employing the audio input/output interface thereof is de-established and a new wireless data communication connection is established to the car kit to enable the usage of the audio input/output interface thereof as an alternative of the headset. The spacious approach of the portable CE device to the proximity of the identification device can be regarded as the user decision to take advantages of the car kit and its functionalities. This is especially evident when referring to radio frequency identification (RFID) technology, which maximal operation distance may be limited such as in the order of centimeters.

Even though the invention is described above with reference to embodiments according to the accompanying drawings, it is clear that the invention is not restricted thereto but it can be modified in several ways within the scope of the appended claims.

1. Electronic device for automated functionality-based selective establishing of wireless data communication connections, comprising:
a wireless data communication interface for communicating wirelessly data with a counterpart device having a corresponding wireless data communication interface; and
an identification device for separately obtaining identification information from a counterpart identification device associated with said counterpart device;
wherein said identification information includes functionality information relating to a functionality of said counterpart device, and wherein said functionality information is adapted to allow for automated functionality-based selective establishing of a wireless data communication connection via said wireless data communication interface with said counterpart device in accordance with said functionality information.

2. Electronic device according to claim 1, wherein said identification information includes configuration information, which allows to establish automatically said wireless data communication connection to said counterpart device by the means of said wireless data communication interface.

3. Electronic device according to claim 2, wherein said configuration information comprises at least one out of a group of configuration information including:
configuration information of said wireless data communication interface and said wireless data communication connection;
identity information;
authentication information; and
address information of said counterpart device.

4. Electronic device according to claim 1, wherein said functionality information comprises at least one out of a group of functionality information including:
information about one or more capabilities of said counterpart device;
information about one or more functions of said counterpart device; and
information about one more features of said counterpart device.

5. Electronic device according to claim 1, comprising a configuring component, which is adapted to:
check if presently one or more wireless data communication connections exists; and
establish said wireless data communication connection in case there do not exist presently any wireless data communication connections.

6. Electronic device according to claim 1, comprising a configuring component which is adapted to:
check whether functionality associated with a presently existing wireless data communication connection corresponds to said profile information; and
establish said wireless data communication connection in case said functionality differs from said profile information.

7. Electronic device according to claim 1, wherein said wireless data communication interface is a low power radio frequency transceiver.

8. Electronic device according to claim 1, wherein said identification device is a radio frequency identification device and in particular a radio frequency identification reader device.

9. Electronic device according to claim 1, wherein said counterpart identification device is a radio frequency identification device and in particular a radio frequency identification transponder device.

10. System for automated functionality-based selective establishing of wireless data communication connections, comprising:
a counterpart device having a wireless data communication interface;
a counterpart identification device associated with said counterpart device; and
an electronic device having a wireless data communication interface for communicating wirelessly data with said counterpart device and an identification device for separately obtaining identification information from said counterpart identification device;
wherein said identification information includes at least functionality information relating to a functionality of said counterpart device, and wherein said functionality information is adapted to allow for automated functionality-based selective establishing of a wireless data communication connection via said wireless data communication interface with said counterpart device in accordance with said profile information.

11. Method for automated functionality-based selective establishing of wireless data communication connections, comprising:
obtaining identification information by an identification device from a counterpart identification device being associated with a counterpart device, wherein said identification information includes at least functionality information relating to a functionality of said counterpart device; and
automated functionality-based selectively establishing a wireless data communication connection via a wireless data communication interface to said counterpart device in accordance with said profile information.

12. Method according to claim 11, wherein said identification information includes configuration information adapted to automatically establishing said wireless data communication connection.

13. Method according to claim 11, comprising:
checking if presently one or more wireless data communication connections exist; and
establishing said wireless data communication connection in case there do not exist presently any wireless data communication connections.

14. Method according to claim 11, comprising:
checking whether a functionality associated with a presently existing wireless data communication connection corresponds to said profile information; and
establishing said wireless data communication connection in case said functionality differs from said profile information.

15. Method according to claim 11, comprising:
requesting a user; and in accordance with a user acknowledgement adding a new wireless data communication connection by establishing said wireless data communication connection
or replacing a presently existing wireless data communication connection by de-establishing said presently existing wireless data communication connection and establishing said wireless data communication connection.

16. Method according to claim 11, wherein said functionality information comprises at least one out of a group of functionality information including:
information about one or more capabilities of said counterpart device;
information about one or more functions of said counterpart device; and
information about one more features of said counterpart device.

17. Method according to claim 11, wherein said obtaining of identification information from said counterpart identification device is triggered by approaching said identification device into a proximity of said counterpart identification device.

18. Method according to claim 11, wherein said identification information includes configuration information, which allows to establish automatically said wireless data communication connection to said counterpart device by the means of said wireless data communication interface.

19. Method according to claim 11, wherein said wireless data communication interface is a low power radio frequency transceiver.

20. Method according to claim 11, wherein said identification device is a radio frequency identification device and in particular a radio frequency identification reader device.

21. Computer program product for executing a method for automated functionality-based selective establishing of wireless data communication connections, comprising program code sections for carrying out the steps of claim 11, when said program is run on a processor-based device, a terminal device, a network device, a portable terminal, a consumer electronic device, or a mobile communication enabled terminal.

22. Computer program product for executing a method for automated functionality-based selective establishing of wireless data communication connections, comprising program code sections stored on a machine-readable medium for carrying out the steps of claim 11, when said program product is run on a processor-based device, a terminal device, a network device, a portable terminal, a consumer electronic device, or a mobile communication enabled terminal.

23. Software tool for automated functionality-based selective establishing of wireless data communication connections, comprising program portions for carrying out the operations of claim 11, when said program is implemented in a computer program for being executed on a processor-based device, a terminal device, a network device, a portable terminal, a consumer electronic device, or a mobile communication enabled terminal.

24. Computer data signal embodied in a carrier wave and representing instructions, which when executed by a processor cause the steps of claim 11 to be carried out.
